(19) United States
(12) Patent Application Publication
(10) Pub. No.: US 2017/0182586 A1
(43) Pub. Date: Jun. 29, 2017

(54) WELD MONITORING SYSTEMS AND METHODS

(71) Applicant: G.E. Schmidt, Inc., Blue Ash, OH (US)

(72) Inventors: Drew Sherlock Johnson, Montgomery, OH (US); Andrew Ryan Johnson, Cincinnati, OH (US); Jonathan Michael Dutton, Cincinnati, OH (US); Dilshan Thilina Modaragamage, Barrie (CA)

(21) Appl. No.: 15/391,842

(22) Filed: Dec. 28, 2016

Related U.S. Application Data
(60) Provisional application No. 62/272,190, filed on Dec. 29, 2015.

(51) Int. Cl. B23K 11/25

(52) U.S. Cl. CPC B23K 11/25

(57) ABSTRACT

A method for monitoring a welding process with a weld monitoring computing system is provided. A weld monitoring system and a controller for a weld monitoring system are also provided.

### REFERENCE TO RELATED APPLICATION

The present application claims priority of U.S. provisional application Ser. No. 62/272,190, filed Dec. 29, 2015, and hereby incorporates the same application herein by reference in its entirety.

### TECHNICAL FIELD

Embodiments of the technology relate, in general, to weld monitoring technology, and in particular to resistance weld monitoring technology that can determine weld integrity and quality.

### BACKGROUND

Conventional welding systems, particularly projection welding, can be susceptible to inconsistencies during the welding process which can adversely affect weld integrity.

### BRIEF DESCRIPTION OF THE DRAWINGS

The present disclosure will be more readily understood from a detailed description of some example embodiments taken in conjunction with the following figures:

FIG. 1 depicts an example weld monitoring controller that can be used with a weld monitoring system according to one embodiment.

FIG. 2 depicts an example method for operating a weld monitoring system according to one embodiment.

FIG. 3 depicts an example schematic of a series of outputs for a weld monitoring system according to one embodiment.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Described herein are example embodiments of apparatuses, systems, and methods for monitoring the quality or integrity of a weld. In one example embodiment, a plurality of stages in the welding process can be monitored to insure weld integrity throughout the welding process. In some embodiments, the weld monitoring system can halt or otherwise stop the welding process in the event that a welding error has been detected. In some embodiments, the weld monitoring system can include a touchscreen and can be controlled by a microprocessor or a computer. The microprocessor or computer can be used to calculate and interpolate data or signals sent from a linear variable displacement transformer (LVDT), where such data or signals can be compared against numerical values and tolerances that are specific to a welding application. In an example embodiment, the welding system can turn on or off relay outputs based on user input or pre-programmed numerical values and tolerances.

The weld monitoring system can include a graphical user interface that can facilitate ease of programming and operation. The weld monitoring system can be designed for use in projection welding applications to monitor and verify projection weld quality. The weld monitoring system can be configured to detect or otherwise monitor any suitable welding stage, feature, or characteristic such as nut or stud presence, that the correct nut or stud is present, whether a nut or stud is positioned correctly, or whether weld penetration is proper.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Example embodiments described herein can be designed to prevent the production of bad quality projection welded components by use of intravenous measures that can be built into the monitoring system. For example, weld monitoring systems and methods can include a series of monitored stages in the welding process that can require verification before the welding process can proceed through each stage. Improperly welded components often must be scrapped, which can increase overall production costs. Welding errors can also cause a machine, system, or line to be shut down for retooling to diagnose an error, to fix machine, or to recalibrate a system. Embodiments of a weld monitor can be designed that can help prevent manufacturers from producing and shipping nut and stud welded components that do not meet industry quality requirements. Embodiments of the weld monitoring system can prevent manufacturers from producing, for example, components with missing nuts or studs, components with upside down nuts or studs, components with the incorrect nut or studs, or components with poorly welded nuts or studs. Example embodiments of the weld monitoring system can determine if not enough or too much weld penetration has occurred. Such systems may be particularly useful in the automotive field.

A weld monitoring computer system in accordance with the present disclosure can be accessed via any suitable technique, such as a web-browser such as SAFARI, OPERA, GOOGLE CHROME, INTERNET EXPLORER, or the like executing on a client device. In some embodiments, the systems and methods described herein can be a web-based application or a stand-alone executable. Additionally, in some embodiments, the systems and methods described herein can integrate with various types of welding systems, such as projection welding systems, and the like. Any suitable client device can be used to access, or execute, the weld monitoring computing system, such as laptop computers, desktop computers, smart phones, tablet computers, gaming system, and the like.

Systems and methods described herein may generally provide an interactive environment for users. Interaction with the weld monitoring system may include, without limitation, keyboard entry, writing from pen, stylus, finger, or the like, with a computer mouse, or other forms of input (voice recognition, etc.). The weld monitoring system may be presented on a tablet, desktop, phone, board, or paper. In one embodiment, the user may interact with a weld monitoring system by writing with a smart pen on normal paper, modified paper, or a hard flat surface of their preference. In this embodiment, the user may receive real-time feedback, or at least near real-time feedback, or may synchronize with a weld monitoring computer system at a later date.

The weld monitoring computer system can be a personal computer, one or multiple computers in server-type system.

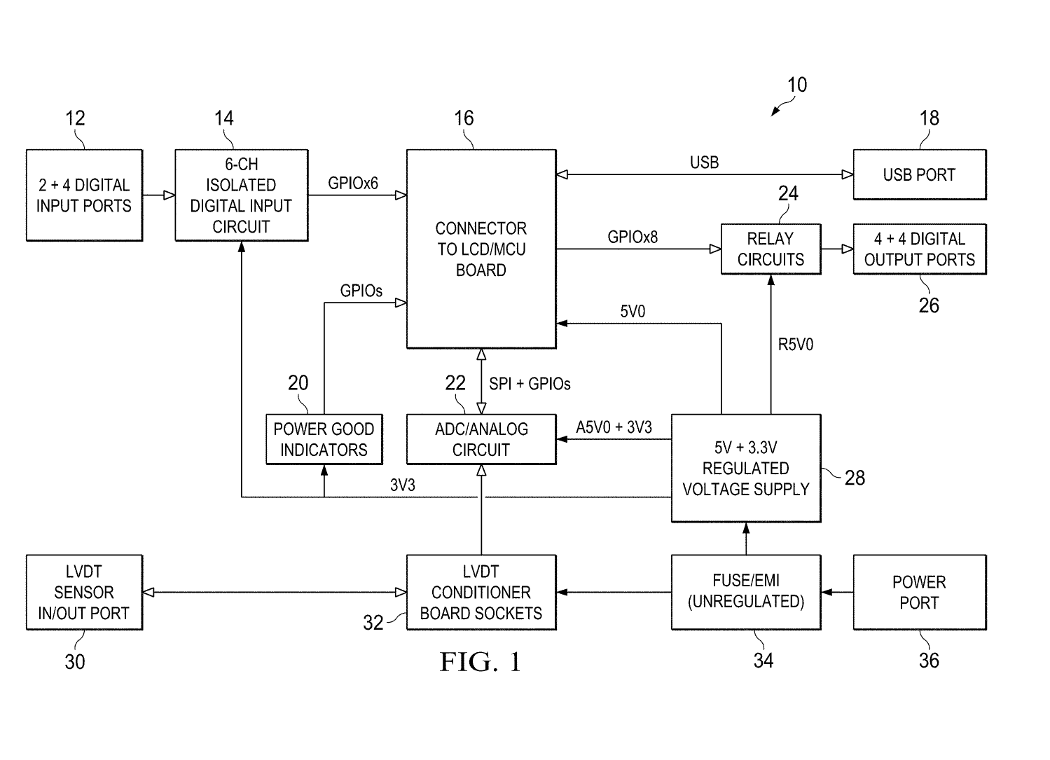

Referring now to FIG. 1, an example embodiment of a weld monitoring computer or controller 10 is shown. The weld monitoring controller can include digital input ports 12, a six channel isolated digital input circuit 14, a connector 16 to an LCD/MCU board, a USB port 18, a power indicator 20, an ADC/analog circuit 22, relay circuits 24, digital output ports 26, a regulated voltage supply, an LVDT sensor in/out port 30, LVDT conditioner board sockets 32, fuse/EMI 34, or a power port 36. It will be appreciated that any suitable number or type of inputs or outputs are contemplated. It will be appreciated that any suitable power source or power input is contemplated. The controller 10 can be associated with any suitable equipment, such as resistance welding equipment, and can be a retrofit system or can be integral with a manufactured system.

The system can include a graphical user interface (not shown) which can allow for easy setup and calibration of the controller 10 and associated welding equipment. The graphical user interface can guide the user with prompts and instructions when calibrating to a system. The system can be configured to allow an operator to calibrate the system in a timely manner without having to read a manual. The graphical user interface can provide information to the user regarding faults and quality issues. This system is not limited to communicating through an alphanumeric display which can only show codes for fault that then has to be looked up in a manual, where dynamics systems and methods are contemplated. Any suitable display, such as providing information in an understandable format without the need for a manual, is contemplated. In example embodiments, the system can communicate in any suitable language such as English, Spanish & German.

The system can include a series of modes that can improve the effectiveness and efficiency of the welding process. Modes can include a bypass mode, a programming mode, and a profile running mode. The system can be placed into a bypass mode where the system may not take any measurements. The purpose of this mode can be to troubleshoot the welder/feeder/robotic cell. This mode can also be used with welding equipment for prototyping new parts without having to setup the monitoring system. In an example embodiment, before the measurement points and windows are programmed, the technician can place the system into the bypass mode and can develop the proper weld schedule for the nut/material combination being welded. Once the proper weld schedule has been developed and weld quality is good, the technician can then setup the system with the proper measurement points and windows.

The programming mode can include setting up and calibrating the system, where a user can follow onscreen instructions on the graphical user interface to program the controller 10 for a particular welding operation on a particular piece of equipment. The system can be designed to monitor the displacement of the weld pin via the LVDT sensor and can make decisions on preprogrammed or calibrated values and turn on or off outputs based on those decisions. In projections welding it can be important to ensure that specific conditions are met prior and after to welding a nut or stud, for example, onto a part in order to prevent producing scrap and to maintain quality standards.

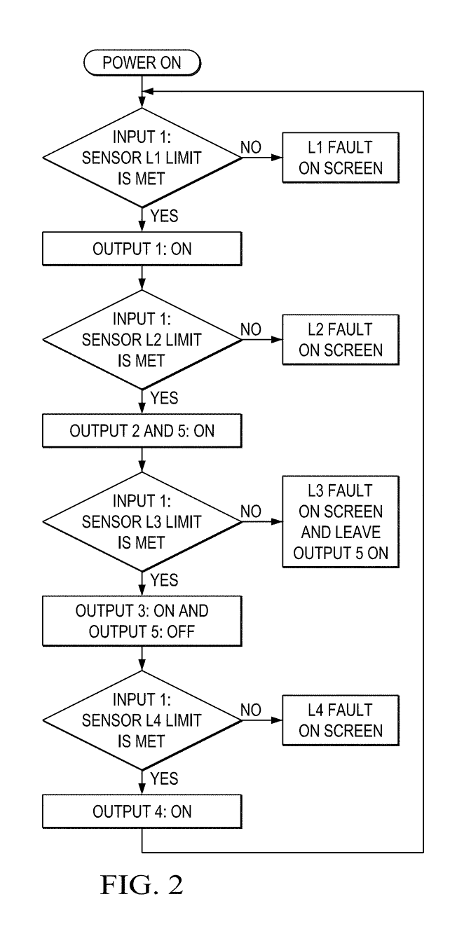

Referring to FIG. 2, by monitoring pin displacement, the system can confirm example weld conditions such as:

Limit 1: Can confirm that the weld pin is up and in weld position ready for a nut to be loaded onto it.

Limit 2: Can confirm that the nut is present, can confirm that the correct nut has been loaded to the pin, can confirm that the correct base material is being used, and/or can confirm that the nut is not upside down.

Limit 3: Can confirm that the weld penetration is sufficient.

Limit 4: Can confirm that the weld pin is retracted down below the electrode face and system is ready for welded parts to be unloaded.

The preset numerical values for each of these limits and their allowable deviations (+/− tolerances), also referred to as windows, can be input into the system via a touchscreen manually by the user during the system calibration process OR the system can be placed into “programming mode” where the system will automatically assign the limit values as well as general tolerances (which can be adjusted if required) simply by welding a nut/stud onto a part.

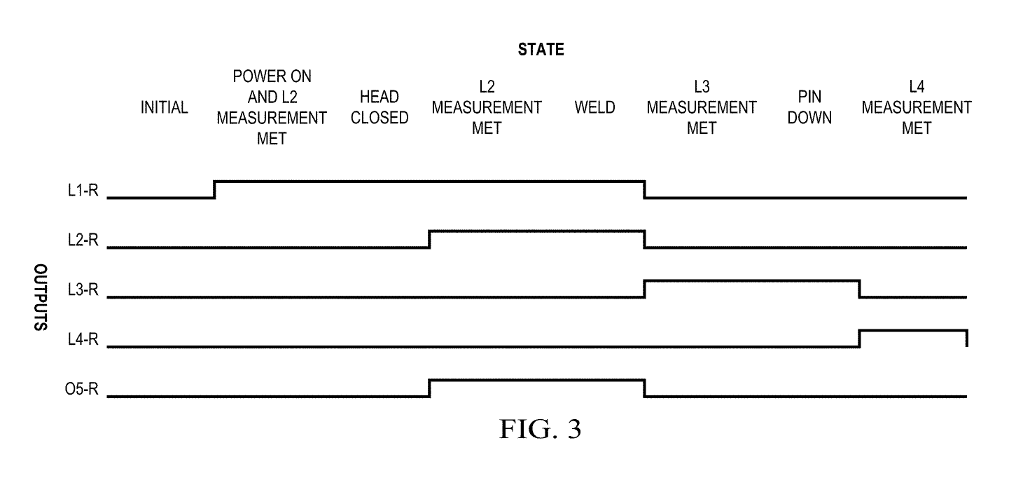

Referring to FIGS. 2 and 3, in an example embodiment of the programming mode, a user can initially set up a profile or select a profile. The system display, for example on the graphical user interface, can prompt the user to ensure that they have developed the required weld parameters for the system in the bypass mode. The system display can then prompt the user to select the profile they would like to program. Once the user selects the profile to program, the system can record the measurement value of an LVDT sensor and assign this as “L1” in the selected profile. In an example embodiment, the system can record the “L1” threshold as a milliamp signal that can be transmitted to programmable logic of the controller 10. “L1” can indicate when the pin is in the correct extended position and the system is ready to measure. When the “L1” threshold is reached, the controller 10 or system can turn “ON” the “L1” relay, which can allow the welding process to proceed. The “ON” position for the “L1” relay can also indicate that there is sufficient power delivery to the system. A user can assign a tolerance to “L1” or, in an alternate embodiment, the system can simply move to the next step of establishing the “L2” threshold. The “L1” threshold can be adjusted automatically based on tare at a later point if desirable.

In establishing the second threshold, which can be designated “L2”, the graphical user interface can instruct the user to load parts onto the pin and to initiate the weld sequence by pressing and holding the palm buttons. Once the user presses the buttons, the welder's head can then close, where the weld monitoring system can then monitor the pin displacement. In an example embodiment, once the slope levels out, the system can assign that signal value, for example in milliamps, to the threshold “L2” of the selected profile. The user or controller 10 can also assign values for an upper or lower window of tolerance for “L2”. The user can adjust the tolerances for “L2” manually in an alternate embodiment. “L2” can also be adjusted automatically based on tare at a later point in the welding process. During operation, once the “L2” threshold has been met, the system can turn “ON” the “L2” relay such that the weld control will fire the weld.

Once the weld control has fired the weld, the controller 10 or system can monitor pin displacement, wait for the slope to level out, and can then assign a signal value to a threshold “L3” of the selected profile. The threshold “L3” can indicate that a correct weld has been formed by the welding equipment. The user or controller 10 can assign values for an upper or lower window of tolerance for “L3”. It can be optional for a user to change the tolerances to “L3” and “L3” can be adjusted automatically based on tare at a later point in the process. During operation, if the signal from the LVDT sensor reaches the threshold “L3”, the system can then turn “ON” the “L3” relay such that a good weld is indicated, the welder's head can open, and the process can begin again. The system has the ability to lock-up the welder if it defines a bad weld has been made. The system can lock-up the head of the welder so that the scrap part produced cannot be removed until an authorized person unlocks the system with a master password.

It will be appreciated that any suitable methods for monitoring a welding process are contemplated. It will be appreciated that any suitable number of thresholds based on any suitable welding characteristics are contemplated including greater or fewer thresholds. Although systems and methods are described as monitoring the output of an LVDT sensor in milliamps, it will be appreciated that other inputs and other signals are contemplated.

In an example embodiment of a welding system, the graphical user interface can prompt a user to determine whether a given profile will use a “head lock function”, where such a function can lock the welding head until the system has been evaluated by a professional to diagnose and fix an error. If the head lock function is enabled, a relay output can be enabled for the profile being programmed. In operation, upon failure to meet the “L3” threshold the welding equipment can be temporarily disabled. The system can also prompt a user to indicate whether the lower electrode pin is retractable, where a “no” response can complete the programming mode and a “yes” response can prompt the user to retract the lower electrode pin. Once the lower electrode pin has been retracted, the controller 10 or system can wait for the slope to level out and can then record the value from the LVDT sensor as threshold “L4”. The tolerances for “L4” can be adjusted based upon the tare at a later point in the process.

In an example embodiment, the system can store data, including profiles, thresholds, or parameters, to be called up when required or requested. For example, in an example embodiment of a weld monitoring system the controller 10 could store ten commonly used welding profiles such that a user simply needs to input the correct profile and the system can be calibrated for the selected application. Such a system can be helpful when welding multiple styles of fasteners and materials on the same machine, where recalibration from scratch can lead to significant downtime and human error. The system can store measurement information for each profile. For example, a user can weld 1000 nuts using a first profile and the system can log the measured numerical values for each programmed preset value (L1, L2, L3, L4). These thresholds can be based on feedback from an LVDT sensor or any other suitable sensor or monitor. The system can also record and log the measured values of pin displacement and related thresholds and send the measurements to a USB or other storage device. Such values can also be transmitted such as to the internet, to another device, to a database, or the like.

The system can store each programmed profile and this data can be downloaded, for example, via a USB port. Stored programs can be shared across machines, can be downloaded to machines, can be purchased for particular applications or parts, or can be provided by manufacturers as default or standard programs. The system can include a binary switch which can be used to select or toggle between two weld schedules, where such a configuration might be useful when a single machine is used to weld two types of components in small batches. The system can be configured for the user to select between a binary input mode and a binary output mode via the user interface. In the binary output mode, the system can send out a binary signal to an external source (e.g., a welder or PLC) based on which profile is selected on the screen or user interface. In binary input mode, in one embodiment, the system can accept a binary signal from an external source that can allow the external source to select a measurement profile for the system to run on. This can allow a machine to switch measurement profiles when running multiple fasteners/ thicknesses. In another embodiment, the binary input can facilitate a PLC or weld control (or other device) to select a profile via the binary inputs. For example, if a part has five different nuts on it and a robot is bringing the part to the welder, the binary input can facilitate assignment of a different profile to each nut and the robot can call up the profile substantially in real-time for the nut being welding.

In an example embodiment, the system can be configured to perform measurements on one product for welding an M6 fastener to a 1 mm thick part and can save those setup conditions to profile #1. The user can then perform the measurements on another product such as an M8 fastener being welded to a 2mm thick part and save those perimeters as profile #2. The system can save an unlimited number of profiles, such as from two profiles to ten profiles, which can be called up when running a particular product that has already been setup.

The system can include counters for each profile, where the user can input a preset value to any of these counters and once that value is reached the system can lock-up and indicate that a counter threshold has been reached. A password can be required to unlock the welder. Such counters can be used for any suitable purposes such as, for example, for maintenance purposes to ensure the caps and pins are changed after a preset amount of welds have been made.

In an example embodiment, the controller 10 or microprocessor can include an algorithm that can automatically shift set-points based on a measured L2 value, which can act as a zero, for every component welded such that false positive and false negative readings can be eliminated or reduced. The system core setup functions can be password protected to prevent tampering by operators, where set profiles may only be accessed by accredited users. The system can include the ability to play videos for instructions, to store a PDF manual that can be called up via a touchscreen, or the ability for the system to send out notifications to users that are connected to the device through Bluetooth, Wireless, Radio or GSM.

### Example Embodiment

### Example System Features:

1. System lockout: password protect system access
2. Bypass mode: The ability to bypass the system when we do not want to take measurements
3. Selectable languages: The system interface be in English or Spanish ie. Buttons, descriptions, etc
4. Multiple profiles: the ability to be able to set up the system to multiple products—ie. To be able to set up the system to perform the measurements on one product for welding an M6 fastener to a 1 mm thick part, save those setup conditions to profile #1. Then, set up the welder to perform the measurements on another product such as an M8 fastener being welded to a 2 mm thick part and save those perimeters as profile #2. The system to have the ability to setup and save 10 profiles which can be called up when running particular product that has already been setup to one of the ten profiles.
5. The ability to record and log the measured values of pin displacement and send the measurements to usb or other storage device.

### Example Inputs:

1. Sensor—LVDT
2. Remote tare—for the purpose of re-zeroing the system with the robot or plc after a pin and electrode change has occurred

### Example Outputs:

1. L1—Pin is in the correct extended position and system is ready to measure
2. L2—Pin is in correct position for fastener/material combination is correct and nut is not upside down
3. L3—Pin is in correct position for good weld penetration. Weld quality is good.
4. L4—Pin is in retracted position
5. Valve Lock Output—Allows us to lock the head of welder in a “bad weld” scenario
6. Binary Signal—This is a binary signal to the weld control. The welder in capable of accepting and processing a binary signal. The purpose of this signal is to select the weld schedule. Each programmed weld schedule in the welder is tied to a binary input in the welder and based on the binary signal the welder receives from our device, the welder will make the decision on what weld schedule to run based in the binary value outputted from the NVS.
7. Binary Signal
8. Binary Signal
9. Binary Signal

Weld Monitoring System Example Input Signals

| | | | | | # of |
|---|---|---|---|---|---|
| Input # | Description | From Source(s) | Signal Type | | Pins |
| 1 | Sensor | LVDT Sensor | AC 5 V at | | 4 |
| | | Signal | 3 KHz | | |
| | | Conditioner | 4-20 mA | | |
| 2 | Remote Tare | PLC | Signal | Common | 2 |

Weld Monitoring System Example Output Signals

| Output | | | | | # of |
|---|---|---|---|---|---|
| # | Description | To Source(s) | Signal Type | | Pins |
| 1 | L1 | PLC (Pin | +24 VDC | Common | 2 |
| | up Condition) | Weld | | | |
| | | Control | | | |
| 2 | L2 (Good Setup | PLC | +24 VDC | Common | 2 |
| | Condition) | Weld | | | |
| | | Control | | | |
| 3 | L3 (Good Weld | PLC | +24 VDC | Common | 2 |
| | Condition) | Weld | | | |
| | | Control | | | |
| 4 | L4 (Pin Retracted | PLC | +24 VDC | Common | 2 |
| | Condition) | Weld | | | |
| | | Control | | | |
| 5 | Valve Lock | Valve | +24 VDC | Common | 2 |
| 6 | Binary Weld | Weld | +24 VDC | | |
| | Initiation 1 | Control | | | |
| 7 | Binary Weld | Weld | +24 VDC | Common | 5 |
| | Initiation 2 | Control | | | |
| 8 | Binary Weld | Weld | +24 VDC | | |
| | Initiation 4 | Control | | | |
| 9 | Binary Weld | Weld | +24 VDC | | |
| | Initiation 8 | Control | | | |

In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semipermanent, and/or semitemporary.

A “computer,” “controller”, “microprocessor”, “computer system,” “host,” “server,” or “processor” can be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments. The memory can also include any means for storing software, including a hard disk, an optical disk, floppy disk, ROM (read only memory), RAM (random access memory), PROM (programmable ROM), EEPROM (electrically erasable PROM) and/or other computer-readable media. Non-transitory computer-readable media, as used herein, comprises all computer-readable media except for a transitory, propagating signals.

In various embodiments disclosed herein, a single component can be replaced by multiple components and multiple components can be replaced by a single component to perform a given function or functions. Except where such substitution would not be operative, such substitution is within the intended scope of the embodiments.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A method for monitoring a welding process with a weld monitoring computing system comprising a controller, the method comprising:
detecting an extended position of a weld pin of a welding system;
confirming positioning of a weld material is proper with respect to the weld pin;
activating a welder to apply a weld joint to the weld material; and
detecting a quality of the weld joint.

2. The method of claim 1 further comprising, when the quality of the weld joint is below a predefined threshold, preventing further operation of the welding system.

3. The method of claim 1 further comprising, when the quality of the weld joint meets or exceeds a predefined threshold, detecting a retracted position of the weld pin and detecting removal of the weld material from the weld pin.

4. The method of claim 1 wherein detecting a quality of the weld joint comprises detecting a penetration depth of a projection weld.

5. The method of claim 1 wherein confirming positioning of weld material is proper with respect to the weld pin comprises confirming that a weld nut is present.

6. The method of claim 1 wherein confirming positioning of weld material is proper with respect to the weld pin comprises confirming that a weld nut is positioned correctly.

7. A weld monitoring system comprising a controller that is operable in one of a bypass mode, a programming mode, and a profile executing mode, the controller having a non-transitory computer readable medium having instructions stored thereon which when executed by a processor cause the processor to:
when in the programming mode:
receive an input from a user identifying a profile from among a plurality of other profiles for programming;
record an extended position of a weld pin of a welding system;
record a first position of a weld head when engaged with a weld material prior to welding;
record a weld duration for welding of the weld material;
record a second position of the weld head when engaged with the weld material after welding; and
record a retracted position of the weld pin; and
when in the profile executing mode:
receive an input from a user selecting the profile for execution from among the plurality of other profiles;
extend the weld pin to the extended position;
move the weld head into the first position;
weld the weld material for the weld duration;
move the weld head into the into the extended position; and
retract the weld pin to the retracted position.

8. The weld monitoring system of claim 7 wherein the processor records the extended position of the weld pin subsequent to automated extension of the weld pin.

9. The weld monitoring system of claim 7 wherein the processor records the first position of the weld head subsequent to automated movement of the weld head into engagement with the welded material.

10. The weld monitoring system of claim 7 wherein the processor records the weld duration of the weld material during automated welding of the weld material.

11. The weld monitoring system of claim 7 wherein the processor records the retracted position of the weld pin subsequent to automated retraction of the weld pin.

12. The weld monitoring system of claim 7 further comprising a graphical user interface and wherein the processor is to record one or more of the extended position, the first position, the weld duration, the second position, and the retracted position from a user input from the graphical user interface.

13. The weld monitoring system of claim 12 wherein the user input further comprises a tolerance range for one or more of the extended position, the first position, the weld duration, the second position, and the retracted position.

14. The weld monitoring system of claim 7 further comprising a graphical user interface and wherein the processor is to record one or more of the extended position, the first position, the weld duration, the second position, and the retracted position from an external memory device.

15. The weld monitoring system of claim 7 wherein, when in the bypass mode, the instructions cause the processor to permit a user to operate the welding system without any recording of events.

16. A controller for a weld monitoring system, the controller comprising:
a sensor input port configured to receive a signal from a monitoring sensor that monitors activity of a welding system;
a plurality of control outputs, each control output being configured to transmit a signal to the welding system to initiate an activity based upon the signal from the sensor input; and
a weld initiation input configured to initiate a welding activity based upon the signal from the sensor input.

17. The controller of claim 16 wherein the plurality of control outputs comprises:
a proper extended position output that is configured to output a signal when a weld pin of a welding system has reached its extended position;
a proper weld setup output that is configured to output a signal when the welding machine is ready for welding;
a proper weld condition output that is configured to output a signal when the welding machine has completed a proper weld; and
a proper retraction position output that is configured to output a signal when a weld pin of a welding system has reached its extended position.

18. The controller of claim 16 further comprising a valve lock output that is configured to output a signal to prevent further operation of the welding system based upon the signal from the sensor input port.

19. The controller of claim 16 further comprising a binary input configured to receive a signal from an external source that selects a profile for the welding system to execute.

20. The controller of claim 16 wherein the monitoring sensor comprises a linear variable displacement transformer.
